(19) United States
(12) Patent Application Publication
(10) Pub. No.: US 2003/0220853 A1
(43) Pub. Date: Nov. 27, 2003

(54) User interface for bill of materials

(76) Inventors: Andrew Back, Farmington, CT (US); James Robert Scanlon, South Windsor, CT (US); Gary Paul Michaelis, Oakville, CT (US); Rick Cornish, Terryville, CT (US); Stanley T. Mason, Hardy, VA (US); Thomas A. St. Louis, Schenectady, NY (US); Mark Edward Dausch, Castleton, NY (US); Vrinda Rajiv, Guilderland, NY (US); Charles Robert Gilman, Troy, NY (US)

Correspondence Address: CANTOR COLBURN, LLP, 55 GRIFFIN ROAD SOUTH, BLOOMFIELD, CT, 06002

(21) Appl. No.: 10/063,904

(22) Filed: May 22, 2002

(51) Int. Cl. G06F 17/60

(52) U.S. Cl. 705/29

(57) ABSTRACT

A method, system, and storage medium encoded with machine-readable computer program code for managing changes in a bill of materials are disclosed and include providing an editor, the editor having a first frame and an adjacent second frame, displaying a parts list in the first frame of the editor, the parts list forming a subset of the bill of materials, and displaying search results from a search for parts in the second frame of the editor. A user interface for managing and navigating a bill of materials, the bill of materials listing a plurality of parts, is disclosed. The user interface includes a first frame including a parts list listing at least a subset of the bill of materials, a second frame providing search results of a search or details of a part listed in the first frame, and a third frame containing function buttons for performing operations between the first frame and the second frame.

### BACKGROUND OF INVENTION

This invention relates generally to a management system for manufacturing planning. More particularly, this invention relates to a user interface for managing Bill of Materials “BOM” changes such as adding parts, removing parts, replacing parts, and changing quantities.

Engineers in design and manufacturing organizations are required to manage large complex Bill of Material structures. The process of managing these structures requires creating and changing these structures in a disciplined and controlled fashion. Bill of Materials are used extensively in the manufacturing process, to assist with material requirements, and to detail the exact formula or recipe for the finished goods. In order to speedup the pace at which consumer demands for a new or modified product are satisfied, manufacturers utilize Bill of Material systems. The term “Bill of Material” or “BOM”, as generally understood in the art and as used herein, refers to a parts explosion listing. Specifically, a product may have many subassemblies, some or all of which may have further subassemblies. A Bill of Material may be a printed out parts list having indentations where the indentations correspond to a depth of hierarchy of each product in each subassembly. The Bill of Material traditionally has been utilized during the manufacturing process of an assembly to provide a reference for the relationship of each component to other components in the assembly.

An example of a system for generating a Bill of material is described in Ferriter et al., U.S. Pat. No. 4,847,761. In the Ferriter et al. system, a Bill of Material generation process begins by producing a functional model of a product design. In order to generate the functional model, the user must know each part required to meet the design specifications, i.e. the user must formulate and apply rules to determine proper subassemblies. The functional model is in the form of a hierarchy tree structure. The tree structure is assigned an item number and stored in a database. Once a tree structure for a product is established, a user can view the hierarchical tree. From this tree structure, the Ferriter et al. system generates a Bill of Material.

Once the Bill of Material is created, it can be used by a manufacturing industry to provide a benchmark to which production is compared for exact manufacturing instructions where component quantities and mixtures are critical. In either case, accuracy of the Bill of Material is critical for material requirements planning “MRP” and accurately projecting costings. Some systems extend the Bill of Materials by adding specific manufacturing details, scrap percentages and packaging/labeling methods. Most provide the ability to add routings to the Bill of Materials. Routings are often referred to as work centers or equipment areas. These routings are used to assist with scheduling the manufacturing processes, adding labor and equipment costs, and even adding start-up and overheads to the Bill of Materials.

Thus, the Bill of Materials is an important part of many manufacturing processes. While systems, such as the Ferriter et al system, for creating a Bill of Materials are known, such systems are limited in their ability as to how the user is able to make and manage any changes.

### BRIEF SUMMARY OF THE INVENTION

The above discussed and other drawbacks and deficiencies of the prior art are overcome or alleviated by a method for managing changes in a bill of materials, the bill of materials listing a plurality of parts. The method includes providing an editor, the editor having a first frame and an adjacent second frame, displaying a parts list in the first frame of the editor, the parts list forming a subset of the bill of materials, and displaying search results from a search for parts in the second frame of the editor.

In another exemplary embodiment of the invention, a system for managing changes in a bill of materials, the bill of materials listing a plurality of parts, is disclosed. The system includes an entry device for entering information related to the parts, a screen for viewing an editor, and a signal processor having memory for storing signals including program signals defining an executable program for providing the editor, the editor having a first frame and an adjacent second frame, displaying a parts list in the first frame of the editor, the parts list forming a subset of the bill of materials, and displaying search results from a search for parts in the second frame of the editor.

In another exemplary embodiment of the invention, a storage medium encoded with machine-readable computer program code for managing changes in a bill of materials, the bill of materials listing a plurality of parts, is disclosed. The storage medium includes instructions for causing a computer to implement a method including providing an editor, the editor having a first frame and an adjacent second frame, displaying a parts list in the first frame of the editor, the parts list forming a subset of the bill of materials, and, displaying search results from a search for parts in the second frame of the editor.

In another exemplary embodiment of the invention, a user interface for managing and navigating a bill of materials, the bill of materials listing a plurality of parts, is disclosed. The user interface includes a first frame including a parts list listing at least a subset of the bill of materials, a second frame providing search results of a search or details of a part listed in the first frame, and a third frame containing function buttons for performing operations between the first frame and the second frame.

The above discussed and other features and advantages of the present invention will be appreciated and understood by those skilled in the art from the following detailed description and drawings.

### BRIEF DESCRIPTION OF DRAWINGS

Referring to the exemplary drawings wherein like elements are numbered alike in the several FIGS.:

FIG. 1 is an exemplary screen capture of a collapsed view of a bill of materials;

FIG. 2 is an exemplary screen capture of an expanded view of a bill of materials;

FIG. 3 is an exemplary screen capture displaying a listing of search results;

FIG. 4 is an exemplary screen capture displaying a listing of expanded search results;

FIG. 5 is an exemplary screen capture of a copy structure selection function;

FIG. 6 is an exemplary dialog box of a property edit screen before committing copy structure;

FIG. 7 is an exemplary screen capture after committing copy structure;

FIG. 8 is an exemplary screen capture of multiple part selections for the Add function;

FIG. 9 is an exemplary dialog box for property edit screen before committing an Add function;

FIG. 10 is an exemplary screen capture after committing an Add function;

FIG. 11 is an exemplary screen capture of part selection before a Remove function;

FIG. 12 is an exemplary screen capture after a Remove function;

FIG. 13 is an exemplary screen capture of part selection before a Replace function;

FIG. 14 is an exemplary dialog box of a property edit screen before committing a Replace function;

FIG. 15 is an exemplary screen capture after a Replace function;

FIG. 16 is an exemplary screen capture of a detail view of a part; and,

FIG. 17 is an exemplary dialog box for selecting views and sorting order.

### DETAILED DESCRIPTION OF THE INVENTION

The user interface provides the users with the interface for maintaining complex structures. Users navigate to the Bill of Materials structure interface through the a change management application. The base node of the Bill of Materials structure is either a Change Request or a Part. Users can choose to browse a structure or edit it.

In the Browse mode, the users can expand and collapse individual nodes or the entire tree. For each node, the Type, Name, and Revision (“TNR”) of a part are displayed. If a node is a Change Request or the parent of the node is a Change Request, the current state of the node is displayed. If the parent of the node is a Part, the attributes of the relationship are displayed. Users may navigate to the details of each node.

In the Edit mode, the users can expand and collapse individual nodes. For each node, the Type, Name, and Revision are displayed. If a node is a Change Request or the parent of the node is a Change Request, the current state of the node is displayed. If the parent of the node is a Part, the attributes of the relationship are displayed. The users can navigate to the details of each node.

A user can search for specific parts or structures. Additionally, a user can maintain the structure by adding a part or structure to a part directly related to a Change Request, remove a part or structure from a Part directly related to a Change Request, replace a child part or structure where the parent Part is directly related to a Change Request, and change the relationship properties of a part to part relationship, as will be further described below.

Referring to the FIGS., the “Structure Editor” or BOM editor allows users to edit Bill of Materials (“BOM”) changes such as adding parts, removing parts, replacing parts, changing sequence numbers, and changing properties. It can be opened from a part or a Change Request by clicking “Structure Editor” button 16 on the button bar 14 of the Engineer (Product Data Management System) main screen 12.

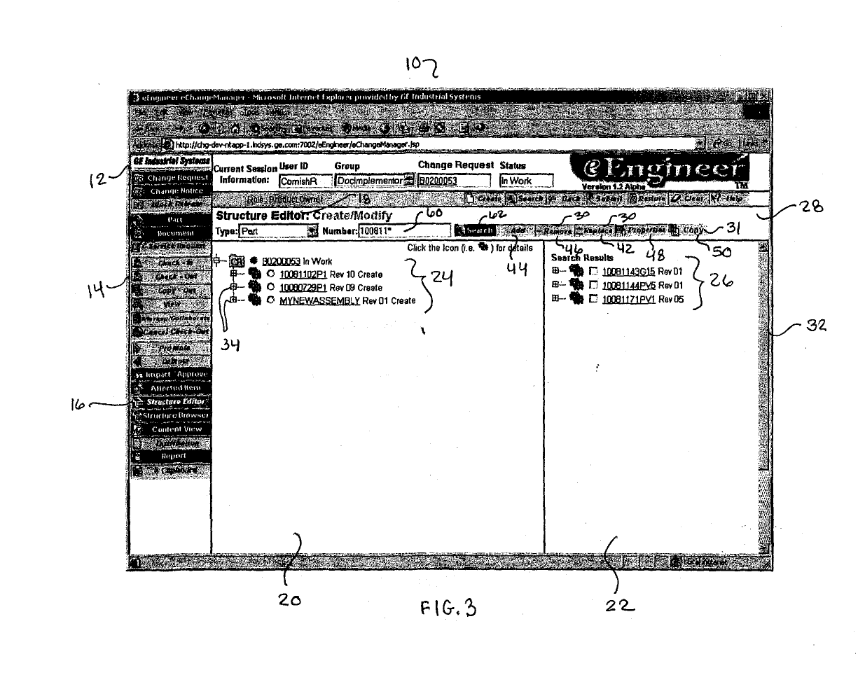

The user interface 10 is preferably a web-based application and has a unique presentation displaying BOM to be modified on left side and Search and Navigate screen on right side. The schema for generating and operating the user interface 10 is disclosed in “Bill of Materials Change Management Schema”, U.S. patent application No. ______ (41 EB-4139/GEN-0319, filed concurrently herewith) and is herein incorporated by reference in its entirety. The user interface 10 preferably allows a user to add and remove multiple parts at once and also copy whole BOM from other Assembly Parts. The Structure Editor 18 (e.g. FIG. 3) has two main frames. The left frame 20 displays BOM 24 to be modified and the right frame 22 displays search results 26 or details of a specific part. There may also preferably be a top frame 28 that holds buttons 30. This top frame 28 preferably stays while user scrolls vertically using scroll bar 32 to view a long list in left or right frames 20, 22.

Although the Structure Editor 18 is described as having right and left sides for presentation of information, it should be understood that the information contained in the right and left sides could be reversed, the information could be displayed in top and bottom windows, or overlapping windows. That is, it is within the scope of this invention to arrange the windows in alternate manners, so long as the integrity of the structure editor 18 remains intact.

If the Structure Editor 18 was opened from a part, it will preferably display the part number on the top of left frame 20. If it was opened from a Change Request which contains a BOM or multiple BOMs, the Change Request number will appear on the top of left frame. Either way, each BOM is displayed with a parent and it's children parts, a collapsed view. If user clicks “Expand” button 38, it will display all the parts at all levels in the BOM, an expanded view. User can expand one level at a time by clicking the “+” icon 34 next to part number or collapse it by clicking the “−” icon 36. The “Expand” 38 and “Collapse” 40 buttons affords a user the ability to expand or to collapse BOM all levels at once.

The buttons 30 on the top button bar 31 gets grayed (inactivated) or highlighted (activated) based on the selections of parts on left and right frames 20, 22. For example, if a part is selected from the left side 20 but nothing is selected from the right side 22, “Replace” button 42 is gray until a part gets selected from the right side 22. That is, an inactive button may be represented by a gray button, or any other color, preferably a dull color. An activated button may be represented by any other color, different than the color of the inactive button, and preferably a brighter color than the inactive button color. For example, an activated button may be a blue color.

When the Structure Editor 18 is open, all of the buttons 30 are preferably in the inactivated state, and thus the inactive button color, such as gray. If a parent is selected from the left side 20, but nothing is selected from the right side 22, then no buttons 30 would be active, for example, the “Add” 44, “Remove” 46, “Replace” 42, “Properties” 48, and “Copy” 50 buttons would be gray. If one part is selected from the right side 22, then “Add” button 44 would switch to the activated color, for example turn blue. The “Copy” button 50 would also become activated if the selected part from the left has no children. If a child is selected from the left side 20, and one part is selected from the right side 22, then the “Remove” 46, “Replace” 42 and “Properties” 48 buttons would become activated. If more than one part is selected, then just the “Remove” 46 and “Properties” 48 buttons would be activated.

When a user clicks on a single part on the right 22, and a parent is selected on the left side 20, then “Add” button 44 is active. “Copy” 50 is also active if the selected part from the left side 20 has no children. If a child is selected from the left side 20, then the “Remove” 46, “Replace” 42, and “Properties” 48 buttons are active. For multiple selections on the right side 22, and a parent is selected on the left side 20, then only the “Add” button is active. If a child is selected from the left, then only the “Remove” 46 and “Properties” 48 buttons are active.

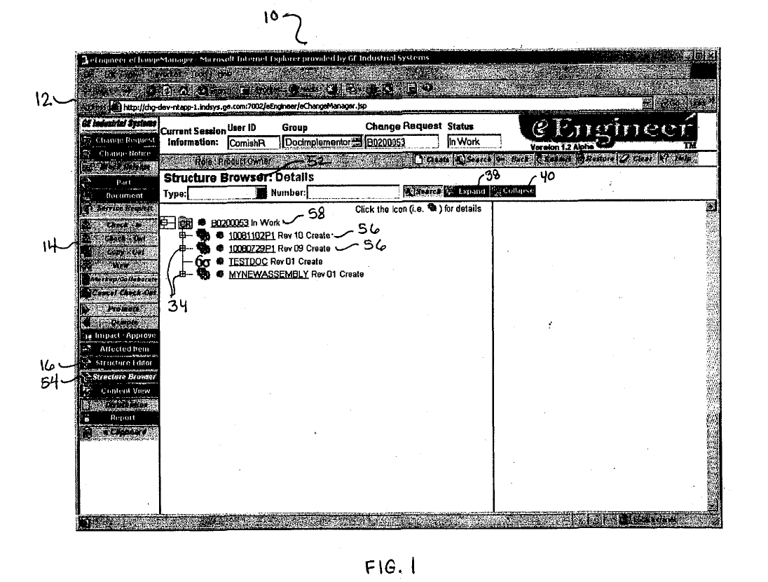

FIG. 1 discloses a Structure Browser screen 52 openable from the Structure Browser button 54 in the button bar 14. As the name implies, the Structure Browser screen 52 may be used to review a BOM, but does not enable the user to make changes as are enabled in Structure Editor 18. In the collapsed view shown in FIG. 1, a top level part 58 which can be expanded one level at a time, the child parts 56, by clicking the + icon 34 or all levels by clicking the “Expand” button 38.

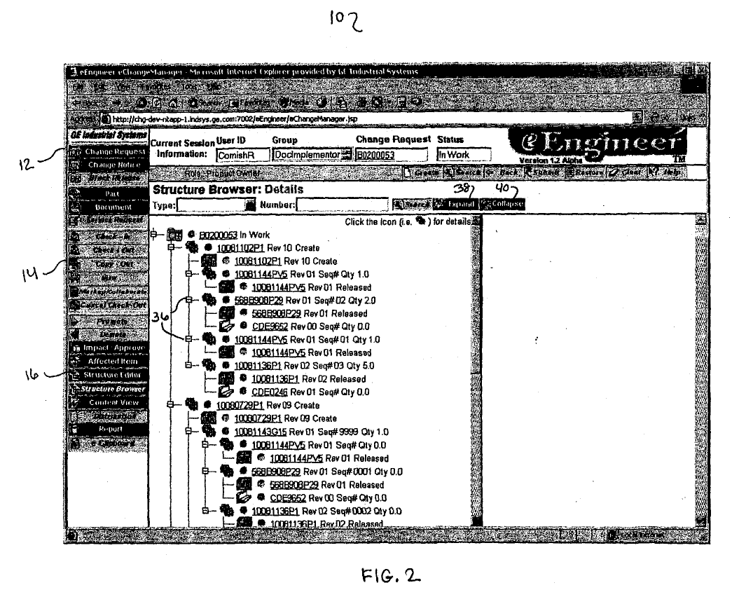

FIG. 2 displays an expanded view of the BOM shown in FIG. 1 which can be collapsed one level at a time by clicking the − icon 36 or all levels by clicking the “Collapse” button 40.

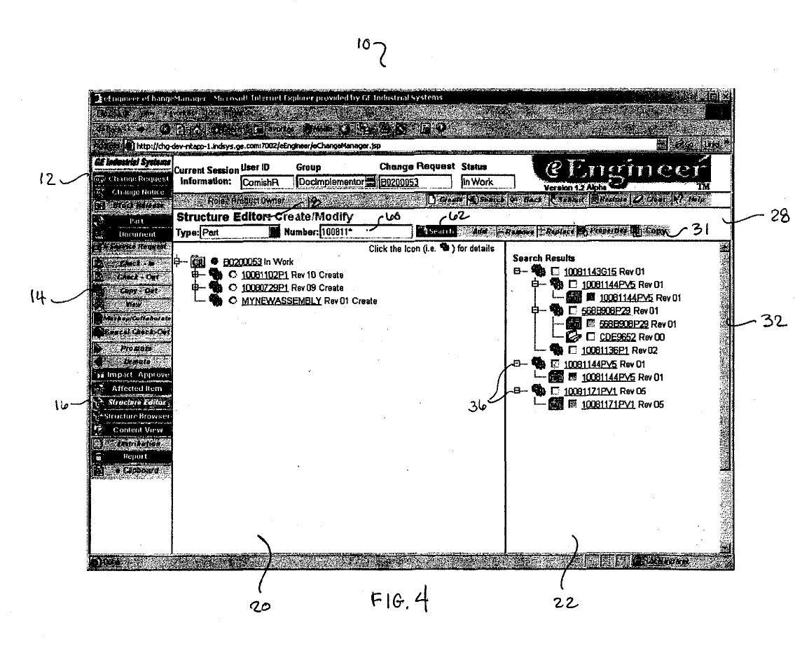

Turning now to FIG. 3, it is shown how a user can search parts and display on right frame 22. The search button 62 is highlighted in FIG. 3. The search results can be expanded or collapsed as previously described. The searching criteria was “100811*”, entered in the data entry box 60, and displayed all parts starting with 100811 on the right frame 22. FIG. 4 shows the expanded view of search results 26 from FIG. 3.

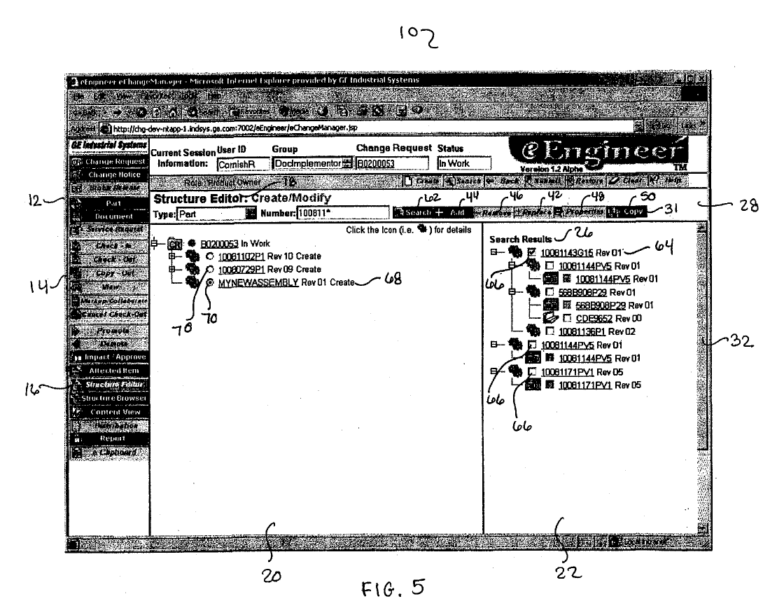

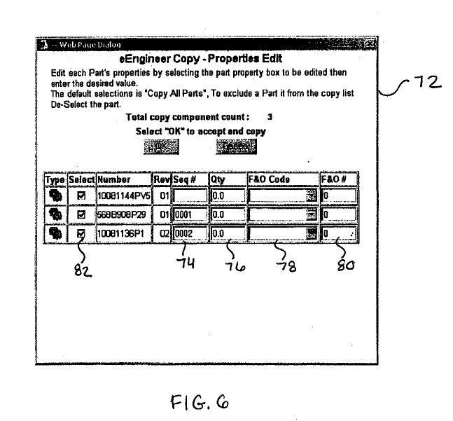

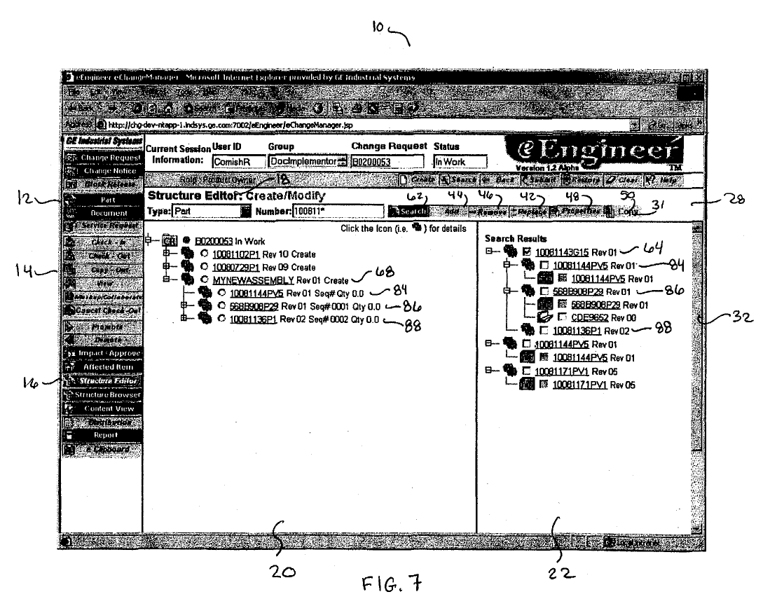

Referring to FIG. 5, if a user has a BOM that should be copied and modified, the “Copy” button 50 may be utilized. The user will not have to click many times to select all the parts in a BOM to add to a select part on the left side 20. Instead, a user may simply select the top level part, e.g. part 64, from search results 26 and click the “Copy” button 50 to copy whole BOM to the selected part, e.g. part 68, on left side 20. The selection box 66 is provided adjacent each part in the search results 26 that may be copied to the left side 20. The parts on the left side 20 are provided with selection circles 70 for selection. As can be seen in FIG. 5, an example of selection before Copy is shown. The selection says that it is desired to copy the BOM of Part 10081143G15, part 64, to Part MYNEWASSEMBLY, part 68, by the checkmark placed in selection box 66 and the dot placed in selection circle 70 by the user. It is within the scope of this invention to provide other selectable shapes adjacent the parts on the left and right sides 20, 22, or to highlight the chosen parts, or to provide any other identifiable selection features. FIG. 6 shows a property screen dialog box 72 where a user can set all the property values before Copy is committed. The dialog box 72 may appear as overlapping the main screen 12. The property or attribute values settable within the dialog box 72 may include sequence number 74 (optional, default to blank), quantity (required, default to 1.0) 76, Feature & Option (“FO”) Code 78 (optional, default to blank, range: “Required”, “Not Required”, “Option”, blank), Feature & Option Number 80 (required if FO Code is not blank, range from 1 to 999). If a user wishes not to copy all parts that are listed, the user may deselect a part by de-selecting (e.g. unchecking) selection box 82. The selection box 82 may toggle between a check mark and a blank box. When a user has completed the attribute information, the “OK” button may be selected to complete the copy function. Alternatively, “Cancel” button may be selected so that the copy function is not completed. FIG. 7 shows that Part MYNEWASSEMBLY, part 68, on the left side 20, now has a BOM just like the BOM of Part 10081143G15, part 64, on the right side 22, because of the Copy function completed. That is, parts 84, 86, and 88 were copied from part 64 to part 68.

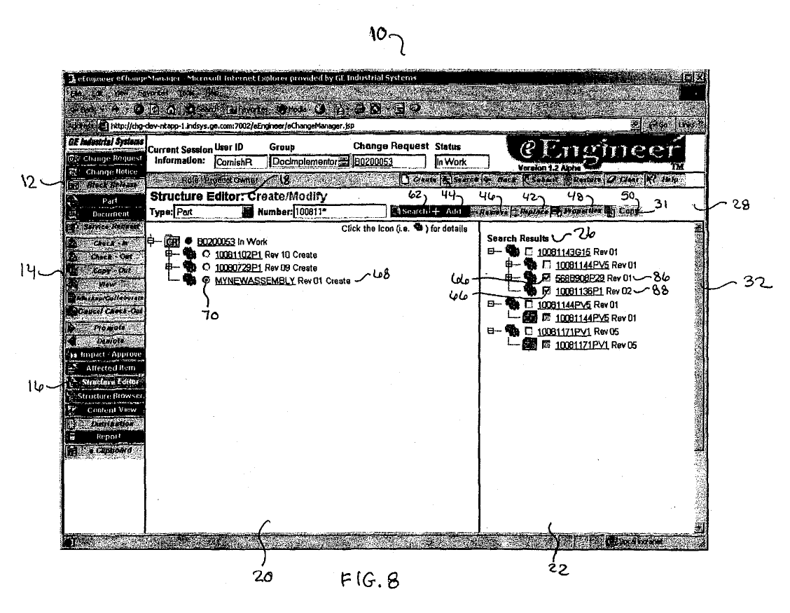

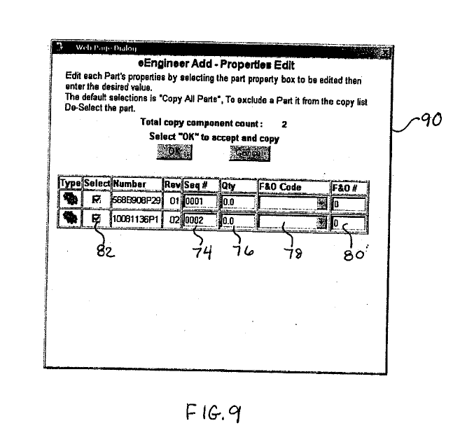

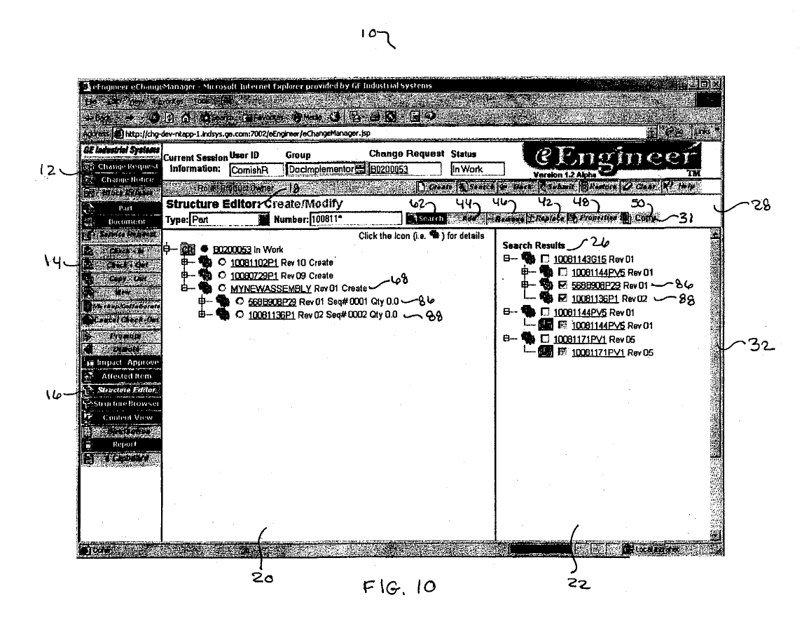

Turning now to FIGS. 8-10, the Add function is described. The Add function allows a user to select one or more parts from search results 26 in the right frame 22 and add the part or parts to the selected part in the left frame 20. FIG. 8 shows that parts 86 and 88 are selected from the right frame 22, by marking selection boxes 66, to be added to the selected part 68 in the left frame 20. FIG. 9 shows the Property screen dialog box 90 before the Add function is committed, with similar attribute requests as shown in dialog box 72 of FIG. 6. FIG. 10 shows the results of adding parts 86 and 88 to part 68.

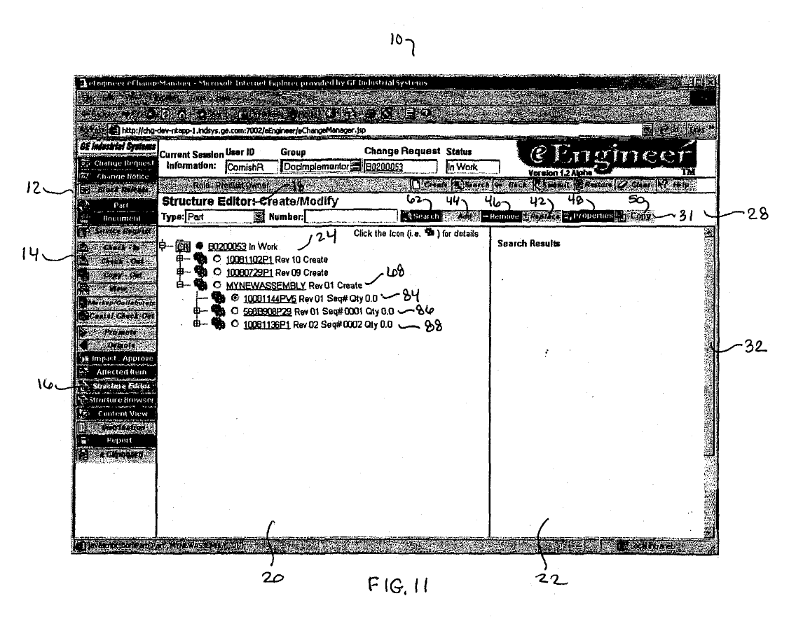

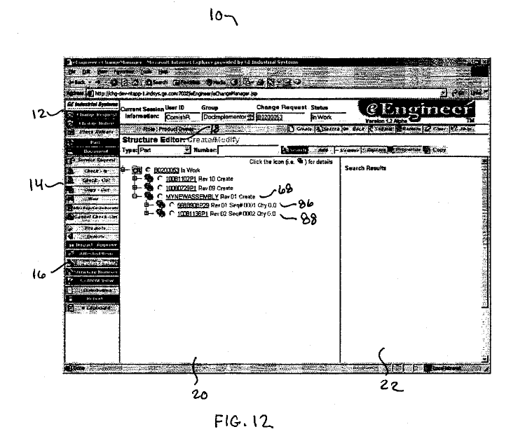

FIGS. 11 and 12 demonstrate the Remove function of the user interface 10. A user can select a part, e.g. part 84, from the left frame 20 and click the Remove button 46 to remove the selected part 84 from the BOM 24. FIG. 11 shows the selected part 84 before removing it. FIG. 12 shows the BOM 24 after removing the selected part 84.

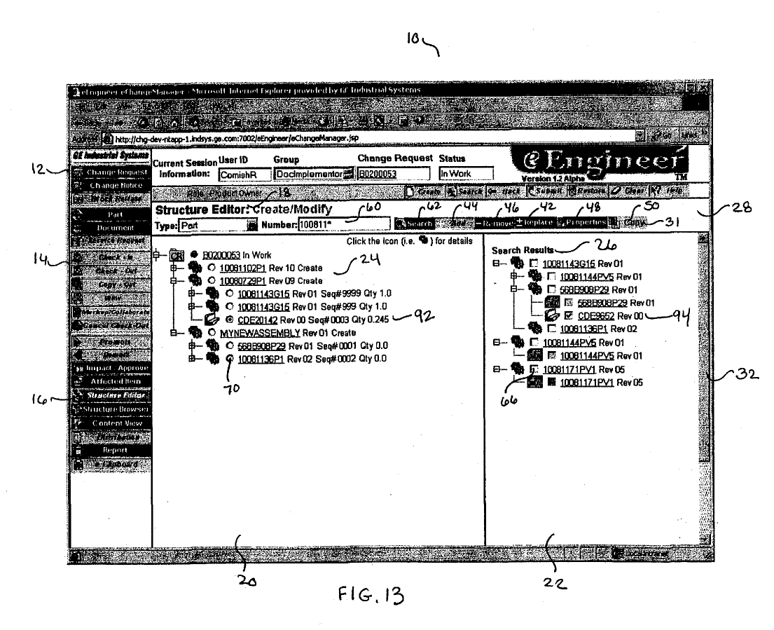

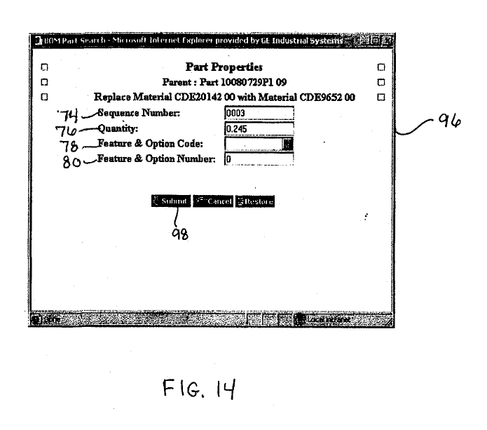

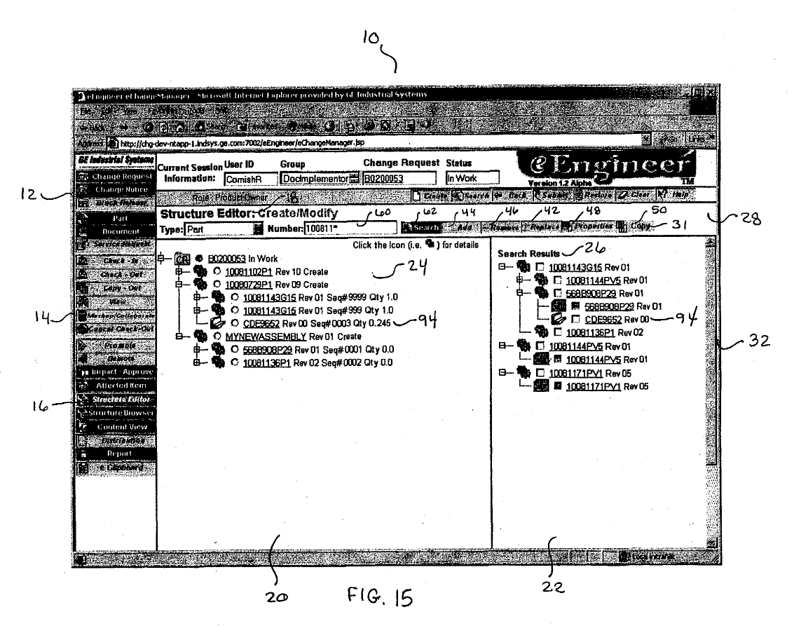

FIGS. 13-15 demonstrate the “Replace” function. A user can replace a selected part from the left frame 20 with a selected part from the right frame 22. FIG. 13 shows that part CDE20142, part 92, is selected by marking selector 70 and that part CDE9652, part 94, is selected by marking selector 66. This indicates that it is desired to replace part 92 with part 94. When the Replace button 42 is clicked, the property screen dialog box 96 shown in FIG. 14 is displayed which enables the user the ability to set properties for part CDE9652, part 94, before committing the Replace function. In addition to the attribute features described above in connection with FIG. 6, the dialog box 96 includes the notation of the parent part TNR (type, number, revision) and a description of the operation (“Replace Material CDE20142 00 with Material CDE9652 00”) that will occur if the “Submit” button 98 is clicked. FIG. 15 shows the BOM 24 with CDE9652, part 94, in place of CDE20142, part 92 (FIG. 13).

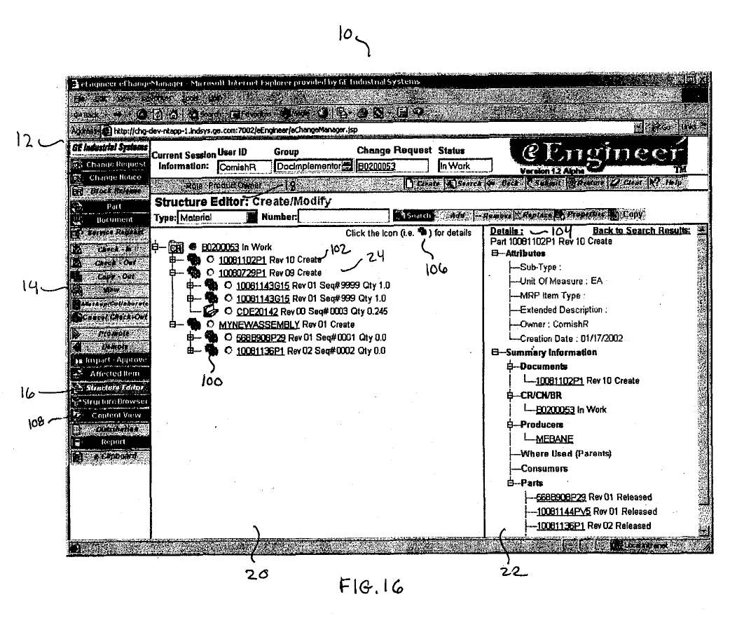

FIG. 16 shows a details display function of the user interface 10. A user can click on the details icon 100 next to a part from the left frame 20 to display detailed information about the part including all attributes, Producers (Plants manufacturing the part), Consumer (Plants using the part), where-used parts, children parts, Documents associated with the part, so on. For example, FIG. 16 shows detailed information 104 on the right frame 22 for part 10081102P1, part 102. The user may toggle between detailed screen 104 and search screen 26 on the right frame 22 by clicking “Back to Search Results” or similar toggle button. Also, a reminder 106 may be posted in the left frame 20, such as “Click the icon (i.e. “icon picture”) for details” to remind the user that such details are easily accessible.

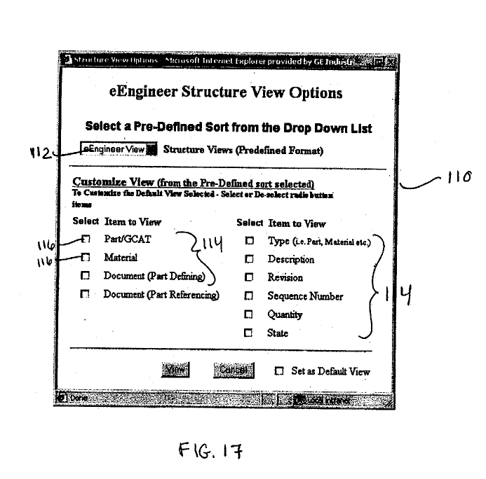

Turning now to FIG. 17, the BOM view option (from View button 108 in button bar 14) gives users the ability to select different views of BOM 24. From the dialog box 110, a user can change the sorting order through the sorting order selector 112 and can further select what objects and attributes 114 are displayed in the BOM 24 by using selectors 116.

The user interface 10 may further include a “mass replace” option which allows a user to identify a part (part 1) to be replaced with another part (part 2). The system will search where the part (part 1) is used by searching all parts in the BOM 24 that uses the part (part 1) user wants to replace with part 2. This allows for the replacement of all parts in the results 26 in a single operation.

The user interface 10 is preferably a World Wide Web based application which is flexible in use. The unique presentation of displaying the BOM to be modified in one frame and the search and navigate information in a separate adjacent frame allows ease in use. The user interface 10 also enables a user to add and remove multiple parts at once and copy whole BOM from other assembly parts.

Thus, the user interface 10 provides the advantages of managing a Bill of Materials structure through the Add, Change Properties, Remove, and Replace functions. One methodology and tool is used for the entire process of managing complex structures. Business rules embedded in the interface 10 and supporting schema ensure that users maintain the integrity of the BOM. The ability to look up an existing structure, navigate the structure and view details for any node, and the ability to expand and collapse the entire structure or any node within it further enhance the use of this user interface 10 with a BOM.

It should be noted that the user interface 10 may be generated and supported through the use of a computer schema and processed by a processing circuit. It is further within the scope of this invention that the disclosed methods may be embodied in the form of any computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or as data signal transmitted whether a modulated carrier wave or not, over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for managing changes in a bill of materials, the bill of materials listing a plurality of parts, the method comprising:
providing an editor, the editor having a first frame and an adjacent second frame;
displaying a parts list in the first frame of the editor, the parts list forming a subset of the bill of materials;
displaying search results from a search for parts in the second frame of the editor.

2. The method of claim 1 wherein providing an editor comprises opening an editor by clicking on an editor button.

3. The method of claim 1 wherein displaying a parts list comprises providing an expandable list of parts.

4. The method of claim 1 further comprising searching for parts by entering either type or name of a part in a third frame of the editor.

5. The method of claim 1 further comprising providing search results in an expandable list format in the second frame.

6. The method of claim 1 further comprising adding a part selected from the search results to a selected location in the parts list.

7. The method of claim 6 further comprising selecting an add button and prompting for entry of part attributes prior to adding a part to the parts list.

8. The method of claim 1 further comprising removing a part from the parts list by selecting a part to be removed and selecting a remove button.

9. The method of claim 1 further comprising replacing a part selected from the parts list with a part selected from the search results.

10. The method of claim 1 further comprising changing an attribute value of a part in the parts list.

11. The method of claim 10 wherein changing an attribute value of a part comprises opening a dialog box and changing a quantity, sequence number, feature and option code, or feature and option number of a part.

12. The method of claim 1 wherein the first frame and the second frame include scroll bars.

13. The method of claim 4 wherein the third frame includes a button bar containing a search button, an add button, a remove button, and a replace button.

14. The method of claim 4 further comprising presenting the first, second, and third frames simultaneously visible in their entirety.

15. The method of claim 14 wherein the first, second, and third frames are contained in a main screen accessible via the World Wide Web.

16. The method of claim 1 wherein each part in the parts list includes a details icon, further comprising selecting a details icon and displaying details of a part adjacent the selected details icon within the second frame.

17. The method of claim 16 further comprising toggling between the search results and the details within the second frame.

18. A system for managing changes in a bill of materials, the bill of materials listing a plurality of parts, the system comprising:
an entry device for entering information related to the parts;
a screen for viewing an editor; and
a signal processor having memory for storing signals including program signals defining an executable program for,
providing the editor, the editor having a first frame and an adjacent second frame;
displaying a parts list in the first frame of the editor, the parts list forming a subset of the bill of materials;
displaying search results from a search for parts in the second frame of the editor.

19. The system of claim 18 wherein the first frame and the second frame occupy discrete portions of the screen.

20. The system of claim 19 further comprising a third frame comprising a data entry text box and function buttons, the third frame occupying a discrete portion of the screen.

21. A storage medium encoded with machine-readable computer program code for managing changes in a bill of materials, the bill of materials listing a plurality of parts, the storage medium including instructions for causing a computer to implement a method comprising:
providing an editor, the editor having a first frame and an adjacent second frame;
displaying a parts list in the first frame of the editor, the parts list forming a subset of the bill of materials;
displaying search results from a search for parts in the second frame of the editor.

22. A user interface for managing and navigating a bill of materials, the bill of materials listing a plurality of parts, the user interface comprising:
a first frame including a parts list listing at least a subset of the bill of materials; a second frame providing search results of a search or details of a part listed in the first frame;
a third frame containing function buttons for performing operations between the first frame and the second frame.

23. The user interface of claim 22 wherein the first frame, second frame, and third frame each occupy a discrete portion of a main screen of an editor.

24. The user interface of claim 22 wherein the third frame includes a data entry text box for entering information for searching.

25. The user interface of claim 22 wherein the function buttons include a search button, an add button, a remove button, and a replace button.

26. The user interface of claim 22 wherein the first frame includes a details icon adjacent each part in the parts list, wherein clicking on a details icon of a selected part displays details of the selected part in the second frame.

27. The user interface of claim 22 wherein the parts list and the search results are each expandable lists including expand and collapse icons.

28. The user interface of claim 22 wherein each part listed in the parts list and each part listed in the search results includes a selection area for selecting a part for performing an editing function.

29. The user interface of claim 22 further comprising a dialog box overlapping at least one of the first frame, the second frame, and the third frame, the dialog box including data entry text boxes for editing a part”s attributes.
